(19) United States
(12) Patent Application Publication
(10) Pub. No.: US 2020/0022483 A1
(43) Pub. Date: Jan. 23, 2020

(54) DENTURE SAVER SYSTEM AND METHOD

(71) Applicant: Ann Marie Pierce, Gainesville, GA (US)

(72) Inventor: Ann Marie Pierce, Gainesville, GA (US)

(21) Appl. No.: 16/518,771

(22) Filed: Jul. 22, 2019

Related U.S. Application Data
(60) Provisional application No. 62/701,195, filed on Jul. 20, 2018.

(51) Int. Cl. A45D 44/20; A61C 19/02

(52) U.S. Cl. CPC A45D 44/20; A61C 19/02

(57) ABSTRACT

Users can place their dentures, invisible braces, and other appliances within the bag for storage. The bag is small and compact, capable of being stored in a pocket, purse, backpack, or the like without worry of contaminating the appliance or the storage location. The bag remains easy to identify if left on a table due the functional indicia thereon. The appliance is kept safe and secure until reinserted into the mouth. Denture Saver can be constructed using absorbent materials.

### CROSS-REFERENCE TO RELATED APPLICATION(S)

The present application is related to and claims priority to U.S. Provisional Patent Application No. 62/701,195 filed Jul. 20, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of storage containers of existing art and more specifically relates to a denture saver system and method.

### RELATED ART

People who wear oral appliances such as dentures, invisible braces, etc. may need to remove the appliance in order to eat, drink, etc. The appliance may be placed in a tissue or paper towel and accidentally thrown away. If the appliance is permanently lost, it may cost an extensive amount of money to replace. A suitable solution is desired.

U.S. Pat. No. 6,341,688 discloses a storage and cleaning apparatus for dentures comprising a plastic bag, the plastic bag including two ends, a top end and a bottom, and two side edges, a first side edge and a second side edge, and the plastic bag also including a triage of reusable seals, the triage being located near the top end and including an upper seal, a middle seal, and a lower seal, each of the seals including a male portion and a female portion, each of the seals extending parallel to each other and located approximately 1 centimeter to ½ inch from each other. In addition, the apparatus includes a cleaning agent assembly, the assembly being located on the inside of the plastic bag. The apparatus also includes a release valve incorporated into a side edge of the plastic bag, and includes pleating located on the lower half of each side edge of the plastic bag.

### SUMMARY OF THE INVENTION

In view of the foregoing disadvantages inherent in the known storage container art, the present disclosure provides a novel denture saver system. The general purpose of the present disclosure, which will be described subsequently in greater detail, is to provide an effective and efficient denture saver system to promote sanitary storage of dentures.

The present invention provides oral appliance users with a small, sanitary, and disposable bag used to store the appliance when not in use. The device utilizes a small, compact construction which allows the bag (device) to be stored in a shirt pocket, pants pocket, or other convenient location. It features an absorbent inner liner to prevent saturation and leaks through a shirt, pants, etc. The device preferably includes a hook and loop fastener enclosure to secure dentures, retainers, braces, etc. within the bag. The present invention offers a way to keep the oral appliance safe, secure, and clean while eating and during other activities.

A denture saver system is disclosed herein comprising a denture case having a body with an exterior surface; an interior surface; a sanitary liner; a thickness; an inner volume; and a flap; wherein the denture case is defined by the exterior surface; the interior surface, the thickness, the inner volume, and the flap; and wherein the flap is able to be manipulated between an open condition and a closed condition, the closed condition such that a pair of dentures is able to be sanitarily stored within the inner volume, the inner volume and the thickness contoured with an (3D) arcuate-shaped bottom and sized to receive the dentures, the dentures resting adjacent to the sanitary liner and able to be sanitized during an in-use condition to maintain the dentures in a sanitary condition.

A method of use for the denture saver system is also disclosed herein, the method comprising the steps of: providing a denture case (bag) as described herein; and inserting dentures into the denture case for sanitary storage. The method may also comprise the steps of: removing the dentures for use; and disposing of the denture case after useful life has been fulfilled.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a denture saver system, constructed and operative according to the teachings of the present disclosure.

FIG. 1 is a perspective view of the denture saver system during an ‘in-use’ condition, according to an embodiment of the disclosure.

FIG. 2 is a perspective view of the denture saver system of FIG. 1, according to an embodiment of the present disclosure.

FIG. 3 is a perspective view of the denture saver system of FIG. 1, according to an embodiment of the present disclosure.

FIG. 4 is a perspective view of the denture saver system of FIG. 1, according to an embodiment of the present disclosure.

FIG. 5 is a perspective view of the denture saver system of FIG. 1, as can be discarded, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a storage container and more particularly to a denture saver system as used to improve the sanitary and readily identifiable storage of dentures.

Generally, the present invention is designed to be disposed of after use and features an absorbent inner liner. The bag can be closed via a hook and loop fastener closure system (or other suitably equivalent means) on the back side. The exterior of the bag can be customized with bright colors and/or a name tag as functional indicia.

Users can place their dentures, invisible braces, and other appliances within the bag for storage. The bag is small and compact, capable of being stored in a pocket, purse, backpack, or the like without worry of contaminating the appliance or the storage location. The bag remains easy to identify if left on a table due the functional indicia thereon. The appliance is kept safe and secure until reinserted into the mouth. Denture Saver can be constructed using absorbent materials. The bags may be available in various colors and sizes to accommodate all user needs and preferences.

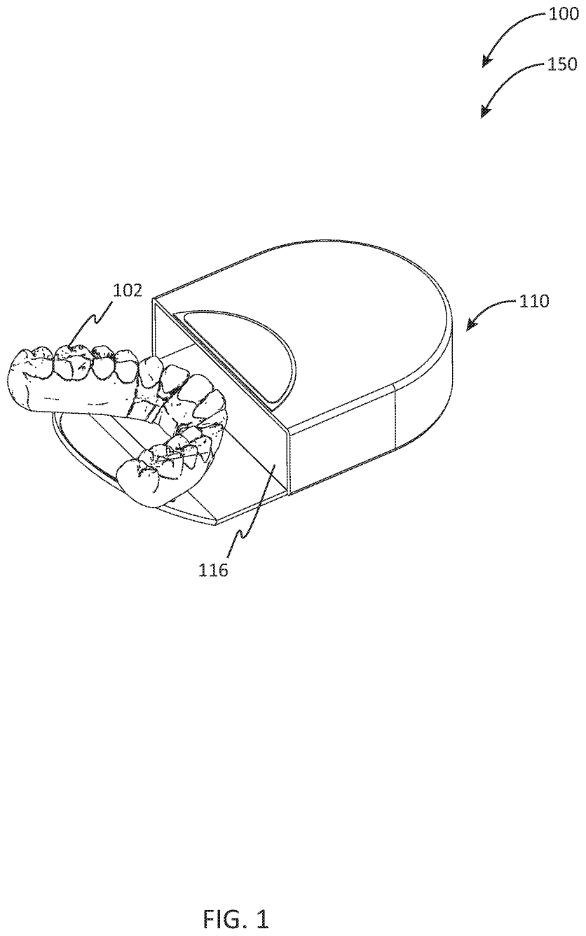

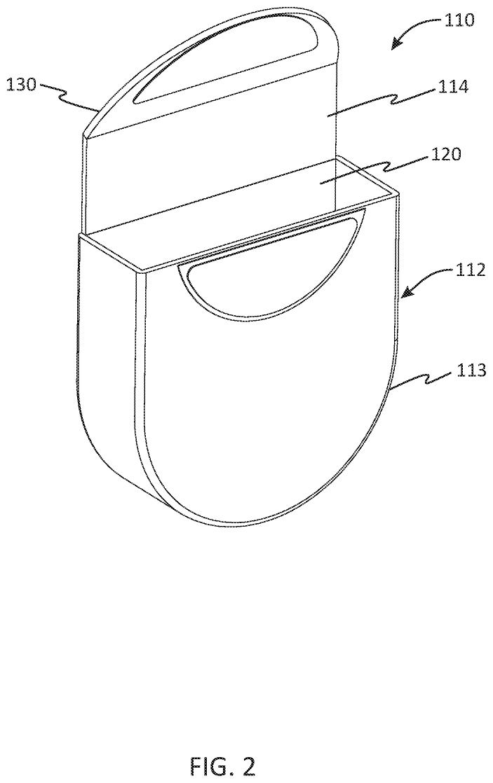

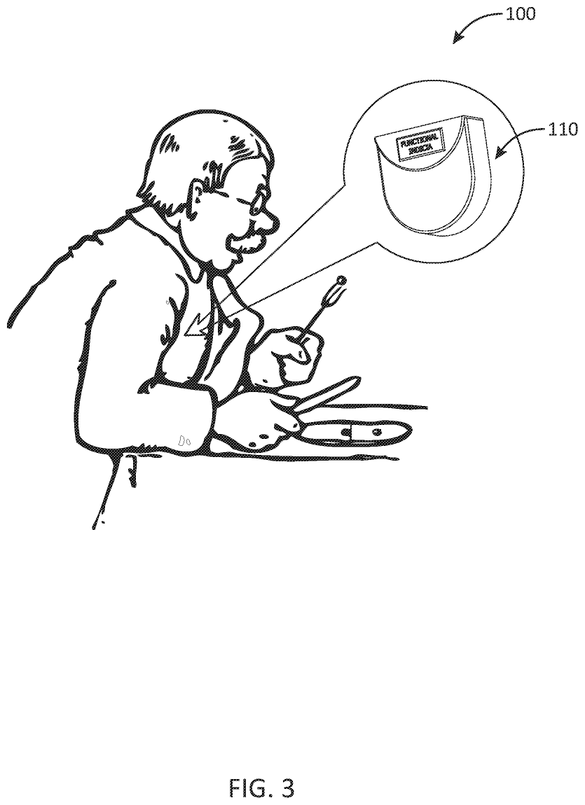

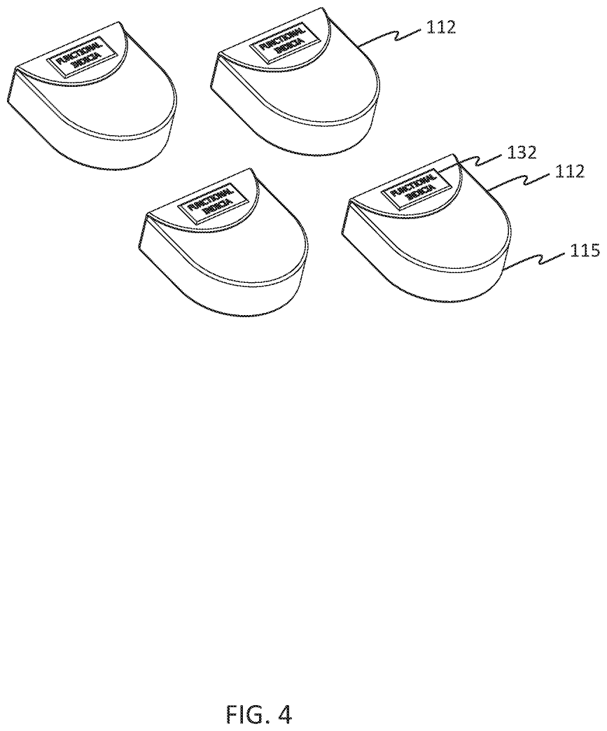

Referring now more specifically to the drawings by numerals of reference, there is shown in FIGS. 1-5, various views of a denture saver system 100.

FIG. 1 shows a denture saver system 100 during an ‘in-use’ condition 150, according to an embodiment of the present disclosure. Here, the denture saver system 100 may be beneficial for use by a user (owner of dentures 102) to safely and sanitarily store dentures 102. As illustrated, the denture saver system 100 may include a denture case 110 having a body 112 with an exterior surface 113; an interior surface 114; a sanitary liner 120; a thickness 115; an inner volume 116; and a flap 130; wherein the denture case 110 is defined by the exterior surface 113; the interior surface 114, the thickness 114, the inner volume 116, and the flap 130; and wherein the flap 130 is able to be manipulated between an open condition and a closed condition; the closed condition such that a pair of dentures 102 is able to be sanitarily stored within the inner volume 116. The inner volume 116 and the thickness 115 is contoured with a (3D) arcuate-shaped bottom and sized to receive the dentures 102, when stored the dentures 102 rest adjacent to the sanitary liner 120 and are able to be sanitized during an in-use condition to maintain the dentures 102 in a sanitary condition.

According to one embodiment, the denture saver system 100 may be arranged as a kit. In particular, the denture saver system 100 may further include a set of instructions. The instructions may detail functional relationships in relation to the structure of the denture saver system 100 such that the denture saver system 100 can be used, maintained, or the like, in a preferred manner.

In preferred embodiments the sanitary liner 120 comprises at least one antiseptic and the sanitary liner 120 is friction-fitting against the dentures 102 during the in-use condition 150. Referring now to the flap 130; the flap 130 is flexible yet semi-rigid to maintain its desired shape for opening and closing through a series of uses. The flap 130 comprises a fastener such as hook and loop or non-hook and loop fastening means for removable attachment to the exterior surface 113. Upon reading this specification, it should be appreciated that, under appropriate circumstances, considering such issues as user preferences, design preference, structural requirements, marketing preferences, cost, available materials, technological advances, etc., other fastener arrangements such as, for example, clips, clasps, hooks, adhesives, snaps, buttons, etc., may be sufficient.

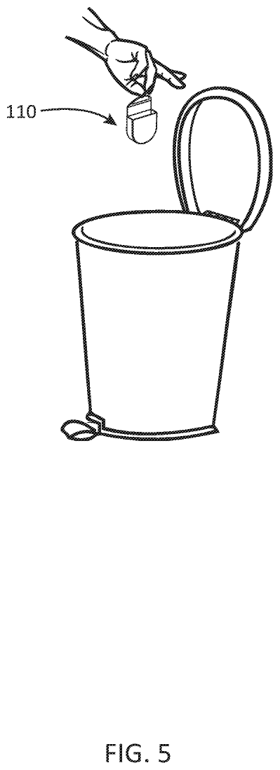

The flap 130 comprises functional indicia 132; wherein the functional indicia 132 may comprise alphanumeric symbols such as a name (Steve; Tony H., or the like). The functional indicia 132 as used comprises readily available (viewable) identification means for example if the device is set on a table with other denture cases 110. The denture case is environmentally-disposable as shown in FIG. 5. The denture case 110 is sized to fit in a (standardized) shirt pocket for ready access. Many sizes may be available. The exterior surface 113 may comprise fabric; plastic; or other such suitable material. In ‘fabric’ embodiments; the fabric provides a friction-surface such that the denture case 110 is restricted from relative movement within and from the shirt pocket so as the denture case 110 is not easily lost during movement of a shirt-wearer.

A method for use of the denture saver system 100, according to an embodiment of the present disclosure may include one or more components or features of the denture saver system 100 as described above. As illustrated, the method for use may include the steps of: providing a denture case as described herein; inserting dentures into the denture case for sanitary storage. The method may also comprise the steps of: removing the dentures for use; and disposing of the denture case after useful life has been fulfilled. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A denture saver system comprising:
a denture case having a body with an exterior surface;
an interior surface;
a sanitary liner;
a thickness;
an inner volume; and
a flap;
wherein said denture case is defined by said exterior surface; said interior surface, said thickness, said inner volume, and said flap; and
wherein said flap is able to be manipulated between an open condition and a closed condition, said closed condition such that a pair of dentures is able to be sanitarily stored within said inner volume, said inner volume and said thickness contoured with an arcuate-shaped bottom and sized to receive said dentures, said dentures resting adjacent to said sanitary liner during an in-use condition to maintain said dentures in a sanitary condition.

2. The denture saver system of claim 1, wherein said sanitary liner comprises wicking means.

3. The denture saver system of claim 2, wherein said sanitary liner comprises at least one antiseptic.

4. The denture saver system of claim 3, wherein the sanitary liner is friction fitting against said dentures during said in-use condition.

5. The denture saver system of claim 4, wherein the flap is flexible.

6. The denture saver system of claim 5, wherein the flap comprises a fastener.

7. The denture saver system of claim 6, wherein the fastener comprises hook and loop.

8. The denture saver system of claim 6, wherein the fastener comprises non-hook and loop fastening means.

9. The denture saver system of claim 8, wherein the flap comprises functional indicia.

10. The denture saver system of claim 9, wherein the functional indicia comprises alphanumeric symbols.

11. The denture saver system of claim 10, wherein the functional indicia comprises a name.

12. The denture saver system of claim 11, wherein the functional indicia comprises readily identification means.

13. The denture saver system of claim 12, wherein the denture case is environmentally-disposable.

14. The denture saver system of claim 13, wherein the denture case is sized to fit in a shirt pocket for ready access.

15. The denture saver system of claim 14, wherein the exterior surface comprises fabric.

16. The denture saver system of claim 15, wherein the fabric provides a friction-surface such that said denture case is restricted from relative movement within and from said shirt pocket so as said denture case is not easily lost during movement of a shirt-wearer.

17. A denture saver system comprising:
a denture case having a body with
an exterior surface;
an interior surface;
a sanitary liner;
a thickness;
an inner volume; and
a flap;
wherein said denture case is defined by said exterior surface; said interior surface, said thickness, said inner volume, and said flap;
wherein said flap is able to be manipulated between an open condition and a closed condition, said closed condition such that a pair of dentures is able to be sanitarily stored within said inner volume, said inner volume and said thickness contoured with an arcuate-shaped bottom and sized to receive said dentures, said dentures resting adjacent to said sanitary liner during an in-use condition to maintain said dentures in a sanitary condition;
wherein said sanitary liner comprises wicking means;
wherein said sanitary liner comprises at least one antiseptic;
wherein the sanitary liner is friction fitting against said dentures during said in-use condition;
wherein the flap comprises a fastener;
wherein the fastener comprises hook and loop;
wherein the flap comprises functional indicia;
wherein the functional indicia comprises a name of an owner of said denture case;
wherein the functional indicia comprises readily identification means;
wherein the denture case is disposable after use; and
wherein the denture case is sized to fit in a shirt pocket for ready access.

18. The denture saver system of claim 17, further comprising set of instructions; and
wherein the denture saver system is arranged as a kit.

19. A method of use for the denture saver system the method comprising the steps of:
providing a denture case having a body with
an exterior surface;
an interior surface;
a sanitary liner;
a thickness;
an inner volume; and
a flap; and
inserting dentures into said denture case for sanitary storage.

20. The method of claim 19, further comprising the steps of:
removing said dentures for use; and
disposing of said denture case after useful life has been fulfilled.
